(19) United States
(12) Patent Application Publication
(10) Pub. No.: US 2024/0036551 A1
(43) Pub. Date: Feb. 1, 2024

(54) NUMERICAL CONTROL DEVICE, NUMERICAL CONTROL SYSTEM, AND SILENCING METHOD

(71) Applicant: FANUC CORPORATION, Minamitsuru-gun, Yamanashi (JP)

(72) Inventor: Yaoki TAKASHIMA, Yamanashi (JP)

(21) Appl. No.: 18/039,375

(22) PCT Filed: Dec. 14, 2021
(86) PCT No.: PCT/JP2021/046109

§ 371 Date: May 30, 2023

(30) Foreign Application Priority Data
Dec. 21, 2020 (JP) 2020-211455

(51) Int. Cl. G05B 19/4155

(52) U.S. Cl. CPC G05B 19/4155; G05B 2219/34013

(57) ABSTRACT

A numerical control device comprises: a control unit that servo-controls a motor; and a silencing data management unit that associates and stores in a storage unit information including at least one of position information and speed information of the motor, and sound data of sound in opposite phase to generated sound. When performing second servo control of the motor that operates according to at least one of position information that is the same as said position information and speed information that is the same as said speed information, the control unit outputs the at least one of the position information and the speed information to the silencing data management unit, and the silencing data management unit reads and outputs the sound data of the sound in opposite phase from the storage unit on the basis of the at least one of the position information and the speed information.

### TECHNICAL FIELD

The present invention relates to a numerical controller, a numerical control system, and a noise reduction method having a function of reducing noise generated during operation of a machine tool, a robot, or an industrial machine by generating a sound in opposite phase to the noise.

### BACKGROUND ART

A machine tool may generate noise during machining, and it is required to reduce the noise. Since the sound generated during machining differs depending on an NC program (Numerically Controlled Program) or a material of a workpiece, it is difficult to predict what kind of sound will be generated unless machining is actually performed. There is a countermeasure against the generation of noise, such as an installation of soundproof walls or covering of a machine with sound proof covers, but such a countermeasure has a problem in terms of cost or installation area. In order to reduce noise generated from the machine tool, Patent Document 1 and Patent Document 2 disclose a device that detects noise and reduces the noise by generating a sound in opposite phase to the noise.

Patent Document 1 discloses an active noise reduction device for an NC machine tool of which operation is controlled by a control command output by an NC device at the time of executing a machining program, the active noise reduction device being configured to detect a generation timing of noise generated by a machine tool by decoding a machining program executed by the NC device, and output a sound in opposite phase to the noise in synchronization with the noise generation timing based on the detected timing and a residual sound detected by a microphone for detecting a residual sound, thereby reducing the noise by interference of sound waves. Patent Document 2 discloses a machine tool device that detects a driving sound, a cooling sound, a cutting sound, and a grinding sound generated at the time of operating a machine tool with a first pressure detector, calculates an opposite-phase signal based on the signal with a calculator, and generates opposite-phase sound waves from a noise reduction speaker provided in the machine tool, thereby reducing the noise.

Further, Patent Document 3 discloses an information system capable of selecting cancelling sound data against an operation sound emitted from a peripheral device externally attached to a device having a sound output function and cancelling the operation sound. Patent Document 3 discloses an information system including an information processing device and a peripheral device separate from and interfaced with the information processing device, the information processing device including a device specifying unit that specifies the peripheral device and a data acquisition unit that acquires operation sound canceling data having phase characteristics for cancelling an operation sound of the peripheral device specified by the device specifying unit. In Patent Document 3, the information processing device includes an operation sound canceling unit, and outputs the operation sound canceling data acquired by the data acquisition unit to a sound output function so as to be output while being superimposed on the sound.

Patent Document 1: Japanese Unexamined Patent Application, Publication No. H7-281673

Patent Document 2: Japanese Unexamined Patent Application, Publication No. H6-270033

Patent Document 3: Japanese Unexamined Patent Application, Publication No. 2011-227219

### DISCLOSURE OF THE INVENTION

### Problems to be Solved by the Invention

In a case of detecting noise in order to reduce noise generated from a machine tool and reducing the noise by generating a sound in opposite phase to the noise, due to feedback control that generates an opposite phase sound based on the generated noise, a delay occurs from a generation or stop of noise to the follow-up of a noise reduction effect. Therefore, it is desirable to provide a numerical controller, a numerical control system, and a noise reduction method with little delay from the generation or stop of noise to the follow-up of the noise reduction effect.

### Means for Solving the Problems

(1) A first aspect of the present disclosure provides a numerical controller that controls a motor that operates a machine tool, a robot, or an industrial machine, the numerical controller including: a control unit that controls the motor in a servo control manner based on a numerical control program; and a noise-reduction data management unit that stores, in a storage unit, information including at least one of position information and speed information of the motor when the control unit performs first servo control on the motor and sound data of a sound in opposite phase to a sound generated by operating the machine tool, the robot, or the industrial machine in association with each other, in which when performing second servo control on the motor operating with at least one of position information equal to the position information and speed information equal to the speed information, the control unit outputs at least one of the position information and the speed information in at least the second servo control to the noise-reduction data management unit, the noise-reduction data management unit reads and outputs the sound data of the opposite-phase sound from the storage unit based on at least one of the position information and the speed information in the second servo control, and the sound data of the opposite-phase sound output from the noise-reduction data management unit is used to cancel the sound generated by the machine tool, the robot, or the industrial machine.

(2) A second aspect of the present disclosure provides a numerical control system including: a plurality of numerical controllers including the numerical controller according to (1) above; and a server connected to the plurality of numerical controllers via a network, in which the server includes a storage unit that stores information including at least one of position information and speed information of a motor when at least one of the plurality of numerical controllers performs first servo control on the motor and sound data of a sound in opposite phase to a sound generated by operating a machine tool, a robot, or an industrial machine in association with each other.

(3) A third aspect of the present disclosure provides a noise reduction method for a numerical controller that controls a motor that operates a machine tool, a robot, or an industrial machine, the noise reduction method including: controlling the motor in a servo control manner based on a numerical control program; storing, in a storage unit, information including at least one of position information and speed information of the motor when first servo control of the motor is performed and sound data of a sound in opposite phase to a sound generated by operating the machine tool, the robot, or the industrial machine in association with each other; when performing second servo control on the motor operating with at least one of position information equal to the position information and speed information equal to the speed information, reading the sound data of the opposite-phase sound from the storage unit based on at least one of the position information and the speed information in at least the second servo control; and using the sound data of the opposite-phase sound read to cancel the sound generated by the machine tool, the robot, or the industrial machine.

### Effects of the Invention

According to each of the aspects of the present disclosure, since the generated sound can be canceled as feed forward in conjunction with at least one of the position information and the speed information, it is possible to obtain a high noise reduction effect with little delay.

### BRIEF DESCRIPTION OF THE DRAWINGS

FIG. 1 is a block diagram showing a machine tool including a numerical controller according to a first embodiment of the present disclosure;

FIG. 2 is a block diagram showing a configuration of an axis control section that controls a motor;

FIG. 3 is a diagram showing a configuration of noise-reduction data;

FIG. 4 is a diagram showing an example of motor drive file information and sound data frame numbers;

FIG. 5 is a diagram showing sampling data included in the motor drive file information and sound data FIG. 6 is a flowchart showing an operation of a machine tool;

FIG. 7 is a flowchart showing noise-reduction data recording processing;

FIG. 8 is a diagram showing motor drive profile information and sound data frame numbers for one NC program;

FIG. 9 is a flowchart showing noise-reduction control processing;

FIG. 10 is a flowchart showing active feedback noise-reduction control processing;

FIG. 11 is a diagram showing a state of canceling and reducing a machining sound with an opposite-phase sound;

FIG. 12 is a diagram showing a setting screen of an operation unit provided in the numerical controller;

FIG. 13 is a block diagram showing another configuration example of a machine tool;

FIG. 14 is a block diagram showing a numerical control system according to a second embodiment of the present disclosure; and

FIG. 15 is a block diagram showing another configuration of the numerical control system.

### PREFERRED MODE FOR CARRYING OUT THE INVENTION

Embodiment of the present disclosure will be described in detail below with reference to the drawings. In the embodiments described below, an example will be described in which a numerical controller controls a motor that operates a machine tool, but the numerical controller can also be used to control a motor that operates a robot or an industrial machine.

### First Embodiment

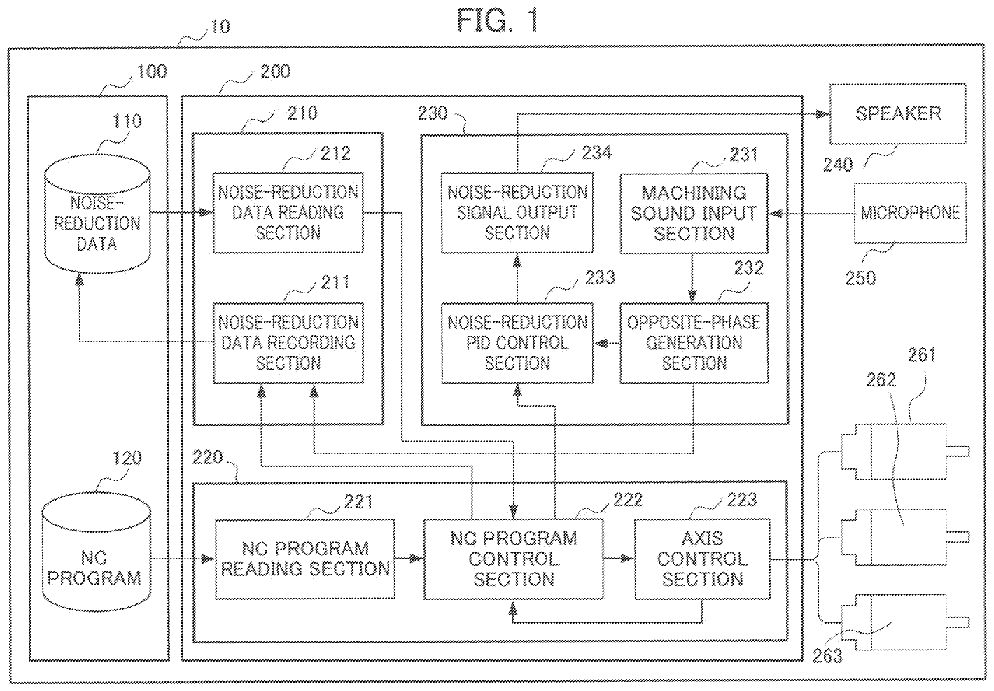

FIG. 1 is a block diagram showing a machine tool including a numerical controller according to a first embodiment of the present disclosure. As shown in FIG. 1, a machine tool 10 includes a storage device 100, a numerical controller 200, a speaker 240, a microphone 250, and motors 261, 262, and 263. The storage device 100 includes a noise-reduction data storage unit 110 that stores noise-reduction data and an NC program storage unit 120 that stores an NC program (numerical control program). Details of the noise-reduction data will be described below. The numerical controller 200 includes a noise-reduction data management unit 210, an NC control unit 220, and a noise reduction control unit 230. Details of configurations and operations of the noise-reduction data management unit 210, the NC control unit 220, and the noise reduction control unit 230 will be described below.

The machine tool 10 has a recording mode and a noise reduction mode. The recording mode is a mode in which the noise-reduction data storage unit 110 records noise-reduction data (including sound data of a sound in opposite phase to noise) for reducing noise generated by machining based on an NC program. The noise reduction mode is a mode to reduce noise generated by machining based on an NC program using the sound data included in the noise-reduction data recorded in the noise-reduction data storage unit 110 or sound data generated by the noise reduction control unit 230. A user selects between the recording mode and the noise reduction mode. In the recording mode, the machine tool 10 performs recording processing of the noise-reduction data including the sound data of the sound in opposite phase to the noise. In the noise reduction mode, the machine tool 10 performs noise-reduction control processing when the noise-reduction data is recorded in the noise-reduction data storage unit 110, and performs active feedback noise-reduction control processing when the noise-reduction data is not recorded in the noise-reduction data storage unit 110. Examples of noise include not only a machining sound generated by machining such as cutting, but also a rotating sound of a motor and a sound of a fan of a cooling device. A case will be described below in which the noise is a machining sound.

### <Recording Mode>

First, the recording mode of the machine tool 10 will be described. In the recording mode, the machine tool 10 performs noise-reduction data recording processing to be described below.

### (Noise-Reduction Data Recording Processing)

The NC control unit 220 reads the NC program from the NC program storage unit 120, and controls the motors 261 to 263 in a servo control manner based on the read NC program. The servo control in the recording mode is a first servo control. Machining is performed by the control of the motors 261 to 263, and the microphone 250 detects the generated machining sound. The noise reduction control unit 230 generates sound data in opposite phase to the sound data (hereinafter, referred to as machining sound data) of the machining sound input from the microphone 250, and inputs the generated sound data to the noise-reduction data management unit 210. The NC control unit 220 inputs, to the noise-reduction data management unit 210, at least one of a position command and a speed command generated based on the NC program. The noise-reduction data management unit 210 associates the opposite-phase sound data with at least one of the position command and the speed command, and stores it as noise-reduction data in the noise-reduction data storage unit 110. The information stored in association with the opposite-phase sound data may be either or both of the position command and the speed command. As described above, the opposite-phase sound data for canceling the machining sound generated by the NC program is stored in the noise-reduction data storage unit 110.

It should be noted that the type of information to be stored in association with the opposite-phase sound data is determined by the user. The information stored in association with the opposite-phase sound data is at least one of the position command and the speed command in the above description, but may be any information indicating at least one of a position and a speed of the motor. The information indicating the position of the motor is not limited to the position command, and may be position feedback information. The information indicating the speed of the motor is not limited to the speed command, and may be speed feedback information. Further, the position command and the position feedback information may be used as the information indication the position of the motor, and the speed command and the speed feedback information may be used as the information indicating the speed of the motor.

However, in the present embodiment, it is more preferable to use, as the information indicating the position and the speed of the motor, respectively, the position command and the speed command generated before the position feedback information and the speed feedback information in noise-reduction control processing to be described below. This is because, by using the position command and the speed command, the opposite-phase sound data stored in the noise-reduction data storage unit 110 can be used as feed forward information for canceling the machining sound. In noise-reduction control processing of the machine tool 10, which will be described below, the information indicating the position and the speed of the motor for reading the opposite-phase sound data may use the position command and the speed command, or may use position feedback information and the speed feedback information in addition to the position command and the speed command.

In addition to the information indicating at least one of the position and the speed of the motor, program step information to be described below may be stored in the noise-reduction data storage unit 110 as the information stored in association with the opposite-phase sound data. The program step information is stored in the noise-reduction data storage unit 110 in association with the opposite-phase sound data, and thus it is possible to clarify which part of the opposite-phase sound data corresponds to which part of the NC program being executed. Furthermore, a file name or a file management number of the NC program may be stored in the noise-reduction data storage unit 110, as the information stored in association with the opposite-phase sound data. The file name or the file management number is stored in the noise-reduction data storage unit 110 in association with the opposite-phase sound data, and thus it is possible to clarify which part of the opposite-phase sound data corresponds to which part of the NC program being executed.

### <Noise Reduction Mode>

A noise reduction mode of the machine tool 10 will be described below. The NC control unit 220 reads, from the NC program storage unit 120, the same NC program as the NC program read during the noise-reduction data recording processing, and controls the motors 261 to 263 in a servo control manner. The servo control in the noise reduction mode is second servo control. The NC control unit 220 inputs at least one of a position command and a speed command generated based on the same NC program to the noise-reduction data management unit 210. The information input to the noise-reduction data management unit 210 is information included in the information stored in association with the opposite-phase sound data in the noise-reduction data recording processing. The user determines the information stored in association with the opposite-phase sound data in advance, and also determines, based on the information stored in association with the opposite-phase sound data, the information input to the noise-reduction data management unit 210. For example, when the information stored in the noise-reduction data storage unit 110 is both of the position command and the speed command, the user sets the information input to the noise-reduction data management unit 210, as the position command or the speed command, or the position command and the speed command. Further, when the information stored in the noise-reduction data storage unit 110 is both of the position feedback information and the speed feedback information, the user sets the information input to the noise-reduction data management unit 210, as the position feedback information or the speed feedback information, or the position feedback information and the speed feedback information. Since the information stored in association with the opposite-phase sound data is information indicating at least one of the position and the speed of the motor, the information input to the noise-reduction data management unit 210 is also information indicating at least one of the position and the speed of the motor. Since the NC program executed in the noise reduction mode is the same as the NC program executed in the recording mode, position information and speed information obtained in the noise reduction mode are the same information as position information and speed information obtained in the recording mode. The NC control unit 220 may input the program step information when the program step information is stored in the noise-reduction data storage unit 110 in association with the opposite-phase sound data. Further, when the file name or the file management number is stored in the noise-reduction data storage unit 110 in association with the opposite-phase sound data, the NC control unit 220 may input the file name or the file management number. In the following description, the information stored in association with the opposite-phase sound data is at least one of the position command and the speed command, and the information input to the noise-reduction data management unit 210 is also at least one of the position command and the speed command.

The noise-reduction data management unit 210 searches for noise-reduction data storage unit 110 based on at least one of the position command and the speed command output from the NC control unit 220, and determines whether the noise-reduction data storage unit 110 stores the noise-reduction data corresponding to at least one of the position command and the speed command. For example, when both of the position command and the speed command are recorded in the information stored in the noise-reduction data storage unit 110, the noise-reduction data management unit 210 determines whether the noise-reduction data storage unit 110 stores the noise-reduction data corresponding to the position command or the speed command, or the position command and the speed command input from the NC control unit 220. The noise-reduction data management unit 210 performs noise-reduction control processing to be described below when the noise-reduction data storage unit 110 stores the noise-reduction data, and performs active feedback noise-reduction control processing to be described below when the noise-reduction data storage unit 110 does not store the noise-reduction data.

### (Noise-Reduction Control Processing)

The noise-reduction data management unit 210 reads, from the noise-reduction data storage unit 110, the opposite-phase sound data retained in the noise-reduction data, and outputs the data to the NC control unit 220. The NC control unit 220 outputs a noise-reduction control instruction including the opposite-phase sound data to the noise reduction control unit 230. The noise reduction control unit 230 outputs an opposite-phase sound from the speaker 240 based on the opposite-phase sound data output from the NC control unit 220, and cancels the generated machining sound. The noise reduction control unit 230 may generate, as error data, the sound data in opposite phase to the sound data of the canceled sound input from the microphone 250, adjust the opposite-phase sound data output from the NC control unit 220 using the error data, perform PID control (Proportional Integral Differential Control) on the sound data, and output the opposite-phase sound from the speaker 240.

### (Active Feedback Noise-Reduction Control Processing)

The noise-reduction data management unit 210 outputs, to the NC control unit 220, a notification that the opposite-phase sound data is not stored. When receiving the notification that the opposite-phase sound data is not stored, the NC control unit 220 outputs an instruction of active feedback noise-reduction control to the noise reduction control unit 230. When receiving the instruction of the active feedback noise-reduction control, the noise reduction control unit 230 generates sound data in opposite phase to the machining sound data of the machining sound input from the microphone 250, performs PID control on the sound data, outputs the opposite-phase sound from the speaker 240, and cancels the generated machining sound.

### <Configuration and Operation of Numerical Control Apparatus>

A description will be given below with respect to configuration and operations of the noise-reduction data management unit 210, the NC control unit 220, and the noise reduction control unit 230 of the numerical controller 200.

The noise-reduction data management unit 210 includes a noise-reduction data recording section 211 and a noise-reduction data reading section 212.

In the noise-reduction data recording processing described above, the noise-reduction data recording section 211 stores, as noise-reduction data, records at least one of the position command and the speed command generated based on the NC program output from the NC control unit 220 and the sound data in opposite phase to the machining sound data of the machining sound output from the noise reduction control unit 230 in the noise-reduction data storage unit 110 in association with each other. In the noise-reduction control processing described above, the noise-reduction data reading section 212 receives a reading instruction including at least one of the position command and the speed command from the NC control unit 220, reads the opposite-phase sound data from the noise-reduction data storage unit 110 based on at least one of the position command and the speed command, and outputs the data to the NC control unit 220. When the noise-reduction data storage unit 110 does not stores the opposite-phase sound data corresponding to at least one of the position command and the speed command output from the NC control unit 220, the noise-reduction data reading section 212 outputs, to the NC control unit 220, a notification that the opposite-phase sound data is not stored.

The NC control unit 220 includes an NC program reading section 221, an NC program control section 222, and an axis control section 223.

The NC program reading section 221 reads the NC program from the NC program storage unit 120, and outputs the NC program to the NC program control section 222.

The NC program control section 222 generates and outputs a position command to the axis control section 223 based on the NC program read from the NC program storage unit 120. In addition, the NC program control section 222 outputs at least one of the position command and the speed command acquired from the axis control section 223 to the noise-reduction data recording section 211 in the noise-reduction data recording processing described above. Further, the NC program control section 222 outputs at least one of the position command and the speed command acquired from the axis control section 223 to the noise-reduction data reading section 212 in the noise-reduction control processing described above, and acquires the opposite-phase sound data associated with at least one of the position command and the speed command from the noise-reduction data reading section 212. Then, the NC program control section 222 outputs, to a noise-reduction PID control section 233, the noise-reduction control instruction including the opposite-phase sound data. Further, when receiving the notification that the opposite-phase sound data is not stored from the noise-reduction data reading section 212 in the active feedback noise-reduction control processing described above, the NC program control section 222 outputs an instruction of active feedback noise-reduction control to the noise-reduction PID control section 233.

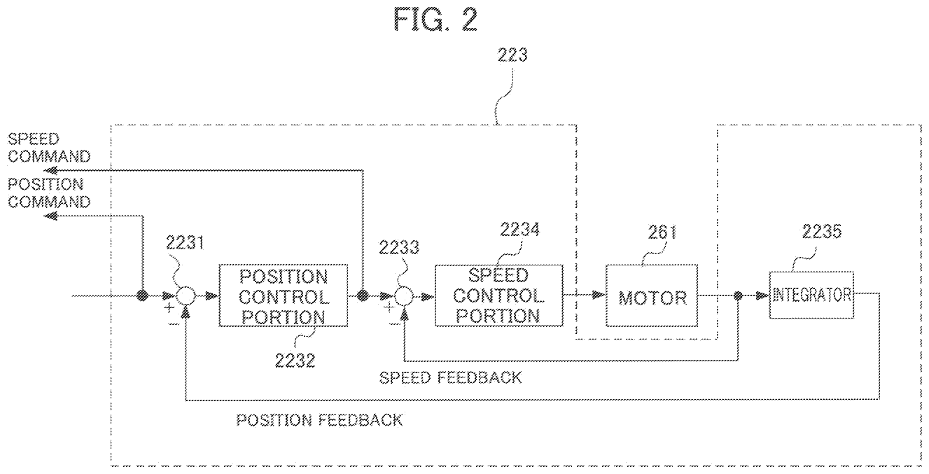

The axis control section 223 includes a subtractor 2231 to which the position command is input, a position control portion 2232, a subtractor 2233, a speed control portion 2234, and an integrator 2235, as shown in FIG. 2. In FIG. 1, the axis control section 223 is connected to the motors 261 to 263, but the axis control section 223 is provided for each of the motors 261 to 263. FIG. 2 shows a configuration of the axis control section that controls the motor 261. For example, when the machine tool is a 3-axis machine and the axis control section 223 machines a workpiece is mounted by moving a table on which a workpiece in an X-axis direction and a Y-axis direction and moving a spindle on which the tool is mounted in Z-axis direction, the axis control section 223 is provided in each of the X-axis direction, the Y-axis direction, and the Z-axis direction.

The subtractor 2231 obtains a difference between the position command and a detection position subjected to a position feedback, and outputs the difference to the position control portion 2232 as a position deviation. The position control portion 2232 outputs a value obtained by multiplying the position deviation by a position gain Kp, to the subtractor 2233 as a speed command. The subtractor 2233 obtains a difference between the speed command and a speed detection value subjected to a speed feedback, and outputs the difference to the speed control portion 2234 as a speed deviation. The speed control portion 2234 adds a value obtained by multiplying the speed deviation by an integral gain K1v and integrating it and a value obtained by multiplying the speed deviation by a proportional gain K2v, and outputs it to the motor 261 as a torque command to drive the motor 261. A rotational angle position of the motor 261 is detected by a rotary encoder, which is associated with the motor 261 and serves as a position detector, and the speed detection value is input to the subtractor 2233 as speed feedback information. The speed detection value is integrated by the integrator 2235 to become a position detection value, and the position detection value is input to the subtractor 2231 as position feedback information.

The noise reduction control unit 230 includes a machining sound input section 231, an opposite-phase generation section 232, a noise-reduction PID control section 233, and a noise-reduction signal output section 234.

The machining sound input section 231 is connected to the microphone 250. The microphone 250 converts the machining sound generated when the machining is performed based on the NC program into machining sound data serving as an electrical signal. The machining sound input section 231 acquires the machining sound data from the microphone 250, and outputs the machining sound data to the opposite-phase generation section 232.

The opposite-phase generation section 232 generates sound data in opposite phase to the machining sound data. The opposite-phase generation section 232 outputs the opposite-phase sound data to the noise-reduction data recording section 211 in the case of the noise-reduction data recording processing described above. In the case of the noise-reduction control processing described above, the opposite-phase generation section 232 outputs the sound data in opposite phase to the sound data of the sound after the machining sound is canceled by the opposite-phase sound, to the noise-reduction PID control section 233. The opposite-phase generation section 232 outputs the opposite-phase sound data to the noise-reduction PID control section 233 in the case of the active feedback noise-reduction control processing described above.

In the case of the noise-reduction control processing described above, when receiving the noise-reduction control instruction including the opposite-phase sound data from the NC program control section 222, the noise-reduction PID control section 233 outputs the opposite-phase sound data included in the noise-reduction control instruction to the noise-reduction signal output section 234 in order to perform the noise-reduction control processing. When the sound data in opposite phase to the sound data of the sound after cancellation is input, as error data, from the sound data opposite-phase generation section 232, the noise-reduction PID control section 233 may use the error data to adjust the opposite-phase sound data output from the NC control unit 220, perform PID control on the data, and output the data to the noise-reduction signal output section 234. When receiving the instruction of the active feedback noise-reduction control in the case of the active feedback noise-reduction control processing described above, the noise-reduction PID control section 233 acquires the opposite-phase sound data from the opposite-phase generation section 232, performs PID control on the data, and outputs the data to the noise-reduction signal output section 234.

The noise-reduction signal output section 234 outputs the opposite-phase sound data output from the noise-reduction PID control section 233 to the speaker 240 in the noise-reduction control processing and the active feedback noise-reduction control processing.

### <Configuration of Noise-Reduction Control Data>

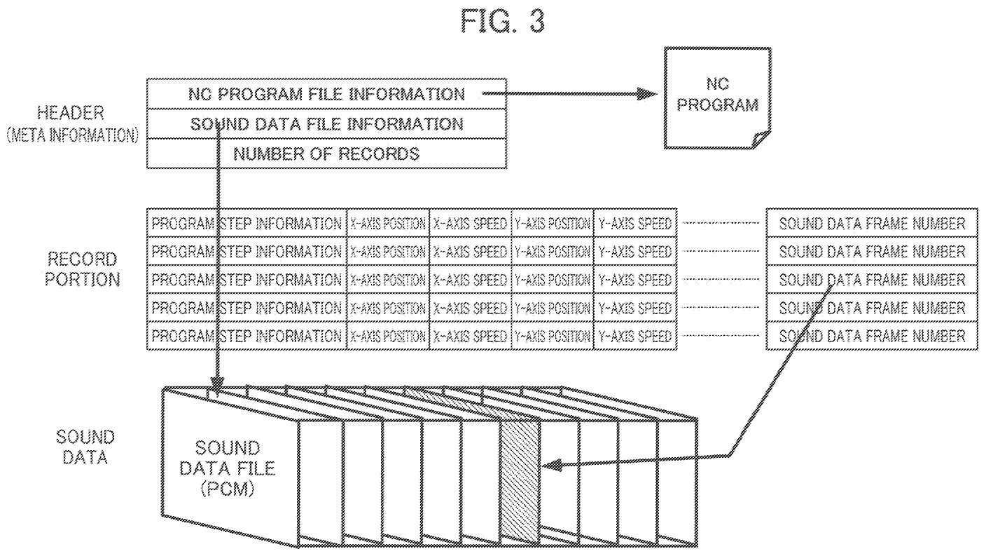

The noise-reduction data stored in the noise-reduction data storage unit 110 by the noise-reduction data recording section 211 has a configuration shown in FIG. 3. FIG. 3 is a diagram showing a configuration of the noise-reduction data. The noise-reduction data recording section 211 records a sampling frame number of digital sound data obtained by converting analog sound data acquired from the opposite-phase generation section 232, according to log data of NC program file information (position information and speed information on each axis) linked to the NC program. The noise-reduction data includes a header, a record portion, and sound data as shown in FIG. 3.

The header is configured by NC program file information, sound data file information, and the number of records. The NC program file information and the sound data file information are information for referring NC program files and sound data files such as file names or file management numbers (hash values). The number of records is the number of recorded files. Information (meta information) of the header does not necessarily have to be recorded in the same file as the record portion as a header of the record portion, and may be recorded in another file or in a meta information portion on the NC program side.

The record portion is configured by motor drive profile information and sound data frame numbers. The motor drive profile information includes program step information and position information and speed information on each axis on each axis. The program step information indicates a program line number of the NC program or an internal step number loaded in units of commands by program analysis of the NC program. As for the position information and speed information on each axis on each axis, in FIG. 3, for example, an X-axis position command is stored as X-axis position information and an X-axis speed command is stored as X-axis speed information. The position information on each axis may include position feedback information in addition to the position command on each axis, and the speed information on each axis may include speed feedback information in addition to the speed command on each axis. The sound data frame number is a number indicating time information in the sound data file of the sound data or information for specifying a sound data reproduction position such as a sampling number.

The sound data includes a plurality of sound data files. The sound data file is recorded as PCM sound data. The sound data file is recorded in a compressed or uncompressed format after AD-conversion of an analog sound input signal in a digitally sampled data format such as 44.1 kHz/16 bit (CD data). In this case, since 44100 sampling points are recorded for one second, it is possible to determine the reproduction position from the sampling number, for example.

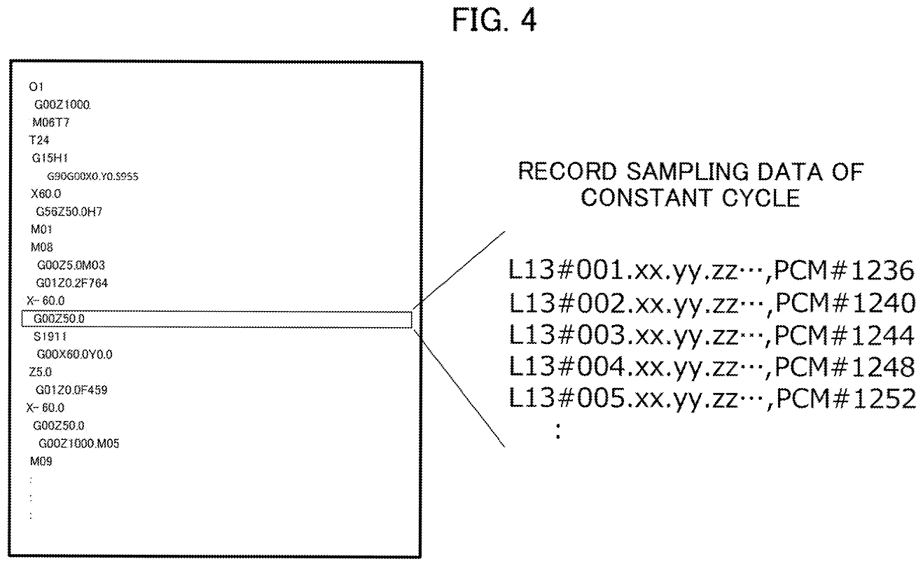

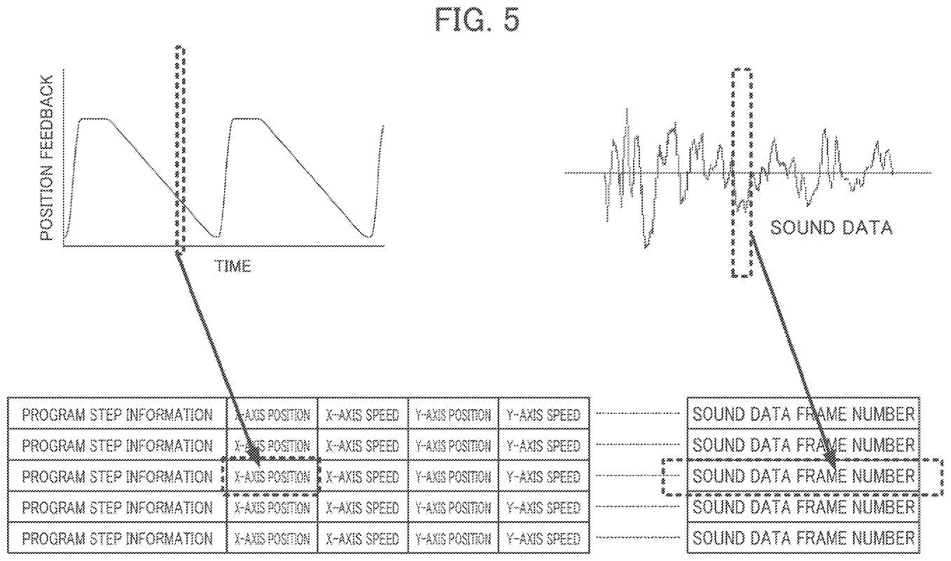

FIG. 4 is a diagram showing an example of motor drive file information and sound data frame numbers. FIG. 5 is a diagram showing sampling data included in the motor drive file information and the sound data. FIG. 4 shows sampling data of a constant cycle. As shown in FIG. 4, the sampling data are “L13 #001.xx.yy.zz . . . , PCM #1236”, “L13 #002.xx.yy.zz . . . , PCM #1240”, “L13 #003.xx.yy.zz . . . , PCM #1244”, “L13 #004.xx.yy.zz . . . , PCM #1248”, and “L13 #005.xx.yy.zz . . . , PCM #1252”. In these sampling data, for example, “L13 #001” indicates program step information, “xx” indicates X-axis position information and X-axis speed information, “yy” indicates Y-axis position information and Y-axis speed information, “zz” indicates Z-axis position information and Z-axis speed information, and “PCM #1236” indicates a sound data frame number. For example, the position information may include position feedback information in addition to the position command, and the speed information may include speed feedback information in addition to the speed command. FIG. 5 shows an example in which, as X-axis position information, an X-axis position command and sampling data of position feedback information as shown in FIG. 5 are recorded and sound data frame numbers corresponding to the sampling data of the sound data shown in FIG. 5 are stored.

The functional blocks included in the machine tool 10 have been described above. In order to implement these functional blocks, the machine tool 10 includes an arithmetic processing unit such as a CPU (Central Processing Unit). Further, the machine tool 10 also includes an auxiliary storage device such as an HDD (Hard Disk Drive) that stores various control programs such as application software or an OS (Operating System) and a main storage device such as a RAM (Random Access Memory) for storing data temporarily required when the arithmetic processing unit executes a program.

Then, in the machine tool 10, the arithmetic processing unit reads the application software or the OS from the auxiliary storage device, loads the read application software or OS in the main storage device, and performs arithmetic processing based on the application software or the OS. In addition, based on the result of arithmetic processing, various hardware included in each of the devices is controlled. Thus, the functional blocks of the present embodiment are implemented. In other words, the present embodiment can be realized by cooperation of hardware and software.

Next, the operation of the machine tool 10 will be described with reference to a flowchart shown in FIG. 6. FIG. 6 is a flowchart showing the operation of the machine tool.

In Step S11, it is determined whether the mode of the machine tool 10 is the recording mode of the noise-reduction data or the noise reduction mode, the process proceeds to noise-reduction data recording processing of Step S12 in a case of a storage mode, and the process proceeds to Step S13 in a case of the noise reduction mode. The noise-reduction data recording processing in Step S12 will be described below.

In Step S13, the noise-reduction data reading section 212 determines whether the noise-reduction data is stored in the noise-reduction data storage unit 110, the process proceeds to noise-reduction control processing of Step S14 when the noise-reduction data is stored, and the process proceeds to Step S15 when the noise-reduction data is not stored. The noise-reduction control processing in Step S14 will be described below.

In Step S15, it is determined whether to continue machining. When the NC program is executed in a state where the noise-reduction data is not acquired, warning is issued to the user that a sufficient noise reduction effect cannot be obtained, a confirmation as to whether to continue the machining is performed, and it is determined based on an instruction of the user that the machining is continued. The confirmation as to whether to continue the machining is based on, for example, interaction through a user interface such as a confirmation dialog or presence/absence of machining parameter setting. When the machining is to be continued, active feedback noise-reduction control processing of Step S16 is performed, and when the machining is to be stopped, the process ends. The active feedback noise-reduction control processing in Step S16 will be described below.

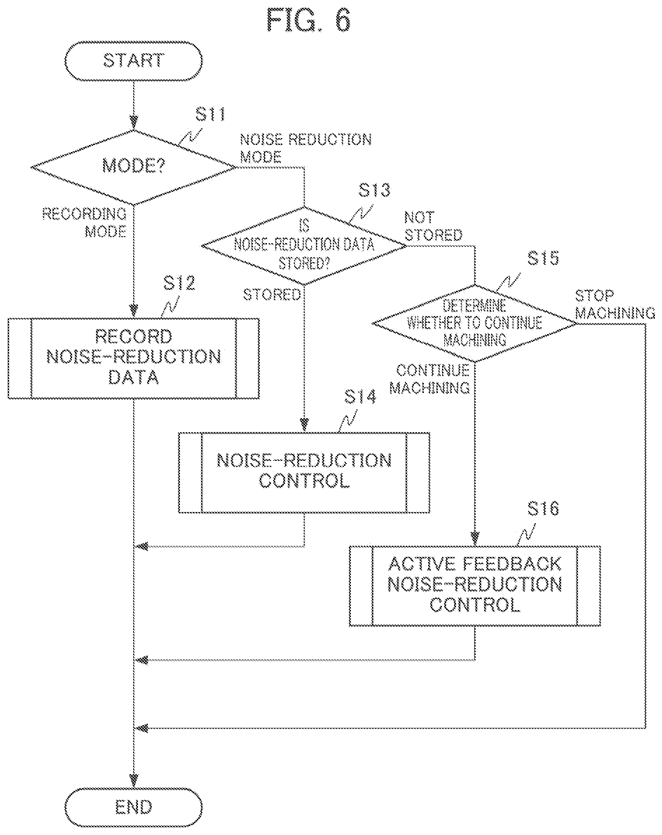

The noise-reduction data recording processing in Step S12 will be described below with reference to FIG. 7. FIG. 7 is a flowchart showing the noise-reduction data recording processing.

In Step S121, the machining sound input section 231 outputs the machining sound data input via the microphone 250 to the opposite-phase generation section 232.

In Step S122, the opposite-phase generation section 232 generates sound data in opposite phase to the machining sound data, and outputs the opposite-phase sound data to the noise-reduction data recording section 211.

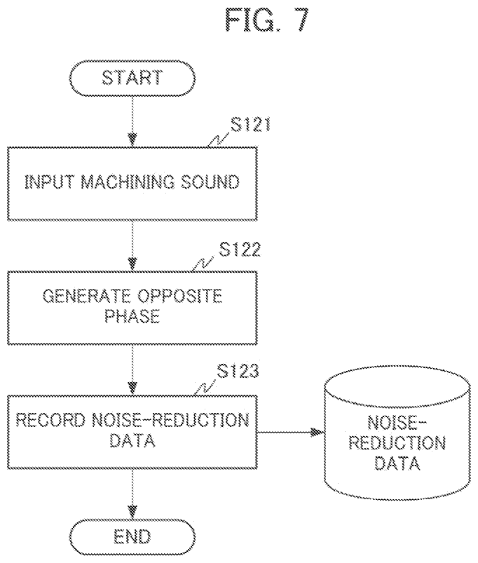

In Step S123, the noise-reduction data recording section 211 stores, as noise-reduction data, stores at least one of the position command and the speed command generated based on the NC program output from the NC program control section 222 and the sound data in opposite phase to the machining sound data output from the opposite-phase generation section 232 in the noise-reduction data storage unit 110 in association with each other. For example, the motor drive profile information and the sound data frame number for a certain NC program are stored in the noise-reduction data recording section 211 as noise-reduction data for program 001 shown in FIG. 8, and the sound data file corresponding to the sound data frame number is also stored in the noise-reduction data recording section 211. FIG. 8 shows an example in which the speed information is not recorded and only axial position information on the X-axis, Y-axis, and Z-axis are recorded.

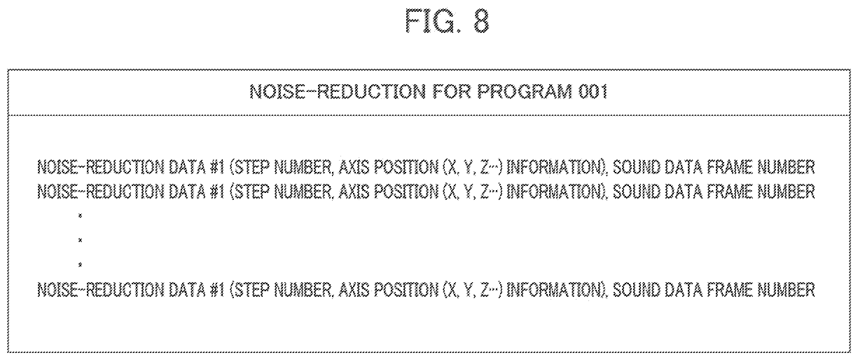

Next, the noise-reduction control processing in Step S14 will be described with reference to FIG. 9. FIG. 9 is a flowchart showing the noise-reduction control processing.

In Step S141, the NC program control section 222 outputs at least one of the position command and the speed command acquired from the axis control section 223 to the noise-reduction data reading section 212, acquires the opposite-phase sound data associated with at least one of the position command and the speed command from the noise-reduction data reading section 212, and outputs the noise-reduction control instruction including the opposite-phase sound data to the noise-reduction PID control section 233.

In Step S142, the noise-reduction PID control section 233 receives the noise-reduction control instruction including the opposite-phase sound data, and outputs the opposite-phase sound data to the noise-reduction signal output section 234.

In Step S143, the noise-reduction signal output section 234 outputs the opposite-phase sound data to the speaker 240 to output a noise-reduction signal.

In Step S144, it is determined whether the NC program has ended, the process proceeds to Step S145 when the NC program has not ended, and the process ends when the NC program has ended.

In Step S145, the machining sound input section 231 outputs the sound data, which is input via the microphone 250, based on the sound after cancellation to the opposite-phase generation section 232. In Step S142 after Step S145, when the sound data in opposite phase to the sound data of the sound after cancellation is input as error data, the noise-reduction PID control section 233 uses the error data to adjust the opposite-phase sound data output from the NC control unit 220 and perform PID control. Thereafter, Steps S143 and S144 are performed.

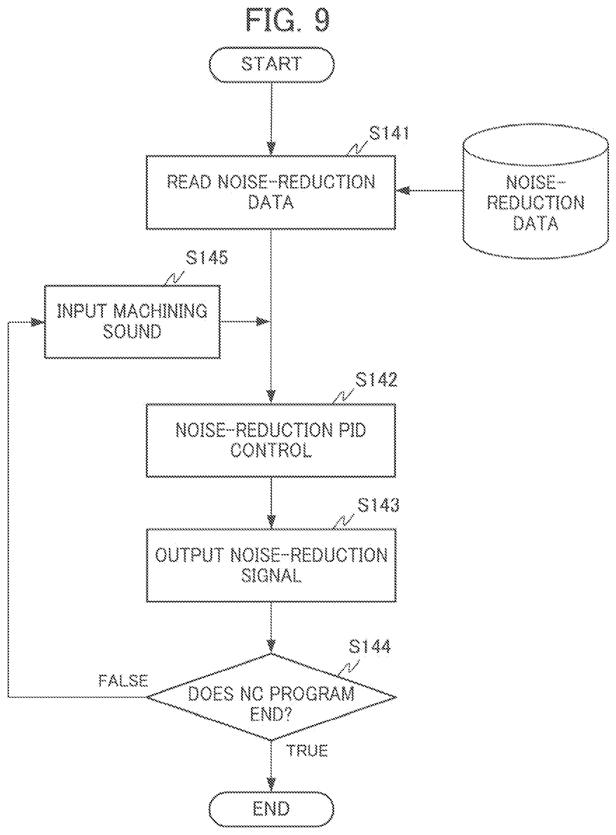

Next, the active feedback noise-reduction control processing in Step S16 will be described with reference to FIG. 10. FIG. 10 is a flowchart showing the active feedback noise-reduction control processing.

In Step S161, the machining sound input section 231 outputs the machining sound data input via the microphone 250 to the opposite-phase generation section 232.

In Step S162, the opposite-phase generation section 232 generates sound data in opposite phase to the machining sound data, and outputs the opposite-phase sound data to the noise-reduction PID control section 233.

In Step S163, the noise-reduction PID control section 233 performs PID control on the opposite-phase machining sound data generated by the opposite-phase generation section 232, and outputs it to the noise-reduction signal output section 234.

In Step S164, the noise-reduction signal output section 234 outputs the opposite-phase machining sound data to the speaker 240 to output a noise-reduction signal. In Step S165, it is determined whether the NC program has ended, the process proceeds to Step S161 when the NC program has not ended, and the process ends when the NC program has ended.

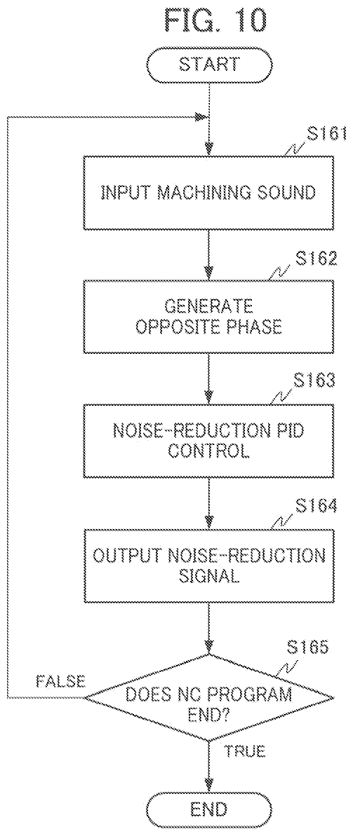

In the embodiment described above, it is preferable to, during a daytime period, measure the machining sound generated during the machining and record the noise-reduction data in the storage mode, and to during a nighttime period at which the reduction of the machining sound is strictly required, switch to a nighttime operation mode and cancel and reduce the machining sound using the noise-reduction data recorded in the daytime period. Furthermore, the feedback control is executed together, and thus the error is also compensated, whereby a noise-reduction effect can also be improved. FIG. 11 is a diagram showing a state of canceling and reducing a machining sound with an opposite-phase sound.

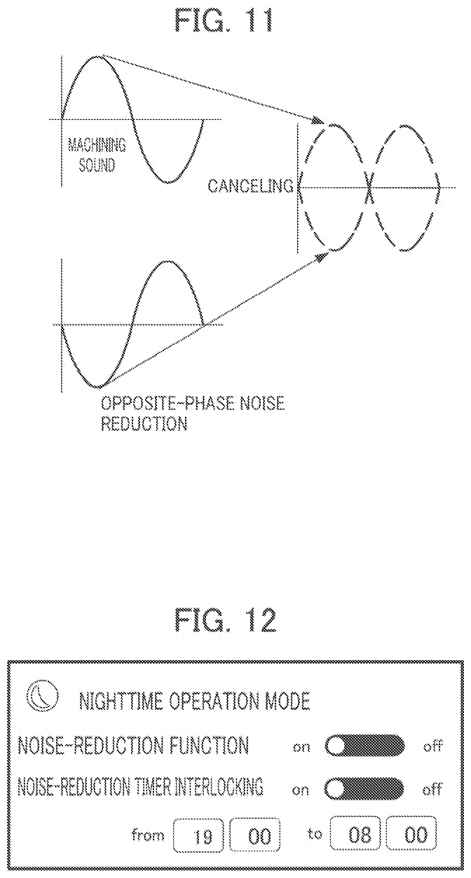

The user may be able to turn ON/OFF a noise-reduction function, turn ON/OFF a noise-reduction timer interlocking function, and set a noise-reduction time in the nighttime operation mode on a setting screen of an operation unit provided in the numerical controller. The operation unit is configured by a liquid crystal display device with a touch panel, for example. FIG. 12 is a diagram showing the setting screen of the operation unit provided in the numerical controller.

In the embodiment described above, since the generated sound can be canceled as feed forward in conjunction with at least one of the position information and the speed information, it is possible to obtain a high noise reduction effect with little delay.

The present embodiment has been described above. The respective component units included in the machine tool or the numerical controller of each embodiment can be implemented by hardware, software, or a combination of the hardware and the software. Further, the servo control method performed by the cooperation of the respective component units included in the machine tool or the numerical controller can also be implemented by hardware, software, or a combination of the hardware and the software. Here, “implementation by software” means implementation by a computer reading and executing a program.

The program may be stored and supplied to a computer using various types of non-transitory computer readable media. The non-transitory computer readable media include various types of tangible storage media. Examples of the non-transitory computer readable media include a magnetic recording medium (for example, a hard disk drive), a magneto-optic recording medium (for example, a magneto-optic disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (Random Access Memory)).

The configuration of the machine tool includes the following configuration in addition to the configuration shown in FIG. 1.

<Modification Example in which the Speaker and the Microphone are Provided Outside and the Noise Reduction Control Unit is Provided Outside the Numerical Controller>

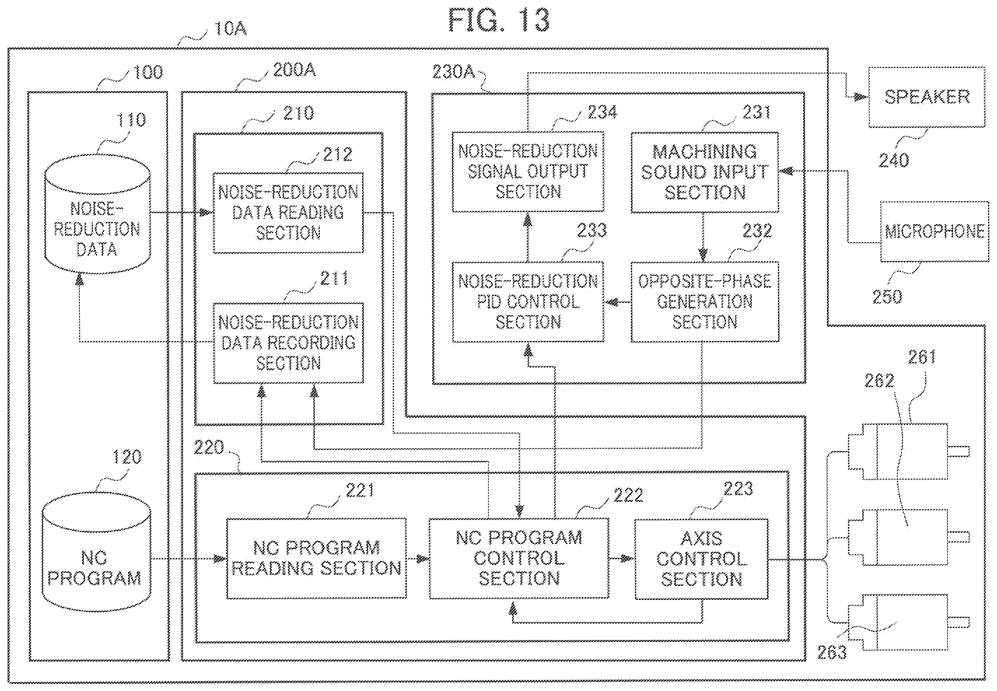

FIG. 13 is a block diagram showing another configuration example of a machine tool. A machine tool 10A shown in FIG. 13 is different from the machine tool 10 shown in FIG. 1 in that the speaker 240 and the microphone 250 are provided outside the machine tool 10A and the noise reduction control unit 230 shown in FIG. 1 is provided outside a numerical controller 200A, as a noise-reduction controller 230A. The numerical controller 200A has the same configuration as the numerical controller 200 except that the noise reduction control unit 230 is not provided. In the machine tool of this configuration example, since the speaker and the microphone are provided outside, it is possible to reduce the machining sound released from the machine tool to the outside. Further, since the noise-reduction controller 230A is provided independently of the numerical controller 200A, the noise-reduction controller 230A can be replaced separately from the numerical controller 200A.

### Second Embodiment

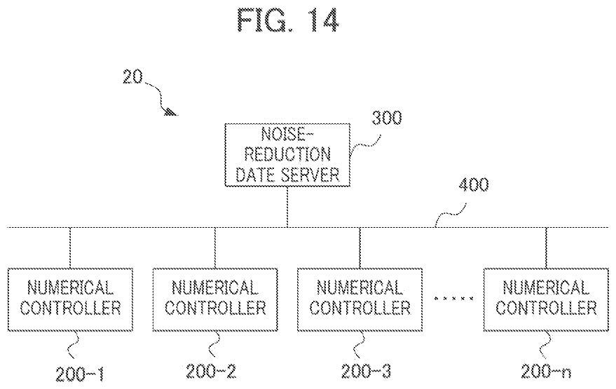

A second embodiment of the present disclosure is a numerical control system including a plurality of numerical controllers and a noise-reduction data server connected to the plurality of numerical controllers via a network. FIG. 14 is a block diagram showing a numerical control system according to the second embodiment of the present disclosure. As shown in FIG. 14, a numerical control system 20 includes n (n being a natural number equal to or more than 2) numerical controllers 200-1 to 200-n and a noise-reduction data server 300 connected to the n numerical controllers 200-1 to 200-n via a network 400. The numerical controllers 200-1 to 200-n have the same configuration as the numerical controller 200 shown in FIG. 1 or the numerical controller 200A shown in FIG. 13. Each of the numerical controllers 200-1 to 200-n is provided in the machine tool. The configuration of the machine tool is the same as that of the machine tool 10 shown in FIG. 1 or the machine tool 10A shown in FIG. 13 except that the noise-reduction data storage unit 110 is not provided. The noise-reduction data server 300 stores noise-reduction data of each of the n numerical controllers 200-1 to 200-n in the storage unit, and transmits the noise-reduction data in response to a request from the noise-reduction data reading section 212 of each of the n numerical controllers 200-1 to 200-n. The noise-reduction data server 300 may store, as error data, sound data generated by the noise reduction control unit 230 and in opposite phase to sound data of a sound after cancellation input from the microphone 250 in the storage unit.

The network 400 is, for example, a LAN (Local Area Network) built in a factory, the Internet, a public telephone network, or a combination thereof. A specific communication system in the network 400 and either of a wired connection and a wireless connection are not particularly limited. In the present embodiment, when the same machining program is shared by a plurality of machine tools for simultaneously production, noise-reduction data measured by a specific numerical controller can be shared by other numerical controllers to perform noise reduction.

<Modification Example of Numerical Control System in which Server Transmits Noise-Reduction Data and NC Program>

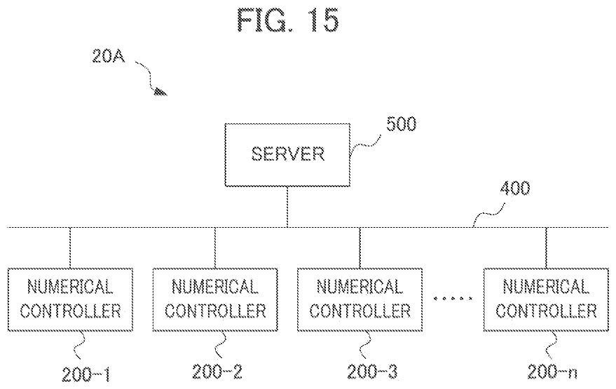

FIG. 15 is a block diagram showing another configuration example of the numerical control system. In a numerical control system 20A of this configuration example, a server 500 is provided in place of the noise-reduction data server 300 of the numerical control system 20 shown in FIG. 14. The server 500 stores noise-reduction data of each of n numerical controllers 200-1 to 200-n, and also stores NC programs to be input to the n numerical controllers 200-1 to 200-n. In the present embodiment, the server 500 can distribute the noise-reduction data together with the NC program when there is no problem with the result of trial machining performed by a certain numerical controller. In the present embodiment, each of the numerical controllers needs not to store the NC program.

Although the first and second embodiments described above are preferred embodiments of the present invention, the scope of the present invention is not limited to only the first and second embodiments described above, and various modifications are possible without departing from the gist of the present invention. For example, in the first and second embodiments, the numerical controller may be provided outside the machine tool. In addition, the storage device 100 shown in FIGS. 1 and 11 may be included in the numerical controller 200 or 200A. In the first and second embodiments described above, the NC program executed in the noise reduction mode is the same as the NC program executed in the recording mode. However, when a part of the NC program executed in the noise reduction mode includes a servo control operation of a motor driven by the position information and the speed information in the second servo control in the noise reduction mode identical to the position information and the speed information in the first servo control in the recording mode, since the sound generated by the second servo control operation can be reduced in the noise reduction mode, the NC program executed in the noise reduction mode may be an NC program different from the NC program executed in the recording mode.

The sounds generated during the machining differ depending on the NC program, but differ depending on the type of the tool or the material of the workpiece. Information of the type of the tool or the material of the workpiece can be included in the noise-reduction data, as CAD data or CAM data (design information for creating the NC program) or parameter information specified by an instruction of the user. When the parameter information is different from parameter information at the time of recording the noise-reduction data, a warning is displayed to confirm whether to perform the noise-reduction control processing.

The numerical controller, the numerical control system, and the noise reduction method according to the present disclosure can take various embodiments having the following configurations including the above-described embodiments. (1) A numerical controller (for example, a numerical controller 200 or 200A) that controls a motor (for example, a motor 261, 262, or 263) that operate a machine tool, a robot, or an industrial machine, the numerical controller including: a control unit (for example, an NC control unit 220) that controls the motor in a servo control manner based on a numerical control program; and a noise-reduction data management unit (for example, a noise-reduction data management unit 210) that stores, in a storage unit, information including at least one of position information and speed information of the motor when the control unit performs first servo control on the motor and sound data of a sound in opposite phase to a sound generated by operating the machine tool, the robot, or the industrial machine in association with each other, in which when performing second servo control on the motor operating with at least one of position information equal to the position information and speed information equal to the speed information, the control unit outputs at least one of the position information and the speed information in at least the second servo control to the noise-reduction data management unit, the noise-reduction data management unit reads and outputs the sound data of the opposite-phase sound from the storage unit based on at least one of the position information and the speed information in the second servo control, and the sound data of the opposite-phase sound output from the noise-reduction data management unit is used to cancel the sound generated by the machine tool, the robot, or the industrial machine. According to the numerical controller, since the generated sound can be canceled as feed forward in conjunction with at least one of the position information and the speed information, it is possible to obtain a high noise reduction effect with little delay.

(2) In the numerical controller according to (1) above, the noise-reduction data management unit stores, in the storage unit, a program line number of the numerical control program or an internal step number loaded in units of commands by program analysis of the numerical control program.

(3) In the numerical controller according to (1) or (2) above, the numerical controller further includes a noise reduction control unit (for example, a noise reduction control unit 230) that outputs the sound data of the opposite-phase sound output from the noise-reduction data management unit so as to cancel the sound generated by the machine tool, the robot, or the industrial machine.

(4) In the numerical controller according to (3) above, the noise reduction control unit adjusts sound data of an opposite-phase sound output from the noise-reduction data management unit, by feedback control using sound data of a sound in opposite phase to the sound after canceling the sound generated by the machine tool, the robot, or the industrial machine.

(5) In the numerical controller according to (3) or (4) above, when the storage unit does not store the sound data of the opposite-phase sound, the noise reduction control unit generates and outputs sound data in opposite phase to the sound generated by the machine tool, the robot, or the industrial machine.

(6) In the numerical controller according to any one of (1) to (5) above, in the first servo control and the second servo control, the position information is position command and the speed information is speed command.

(7) A numerical control system including: a plurality of numerical controllers including the numerical controller according to any one of (1) to (6) above; and a server (300 or 500) connected to the plurality of numerical controllers via a network, in which the server includes a storage unit that stores information including at least one of position information and speed information of a motor when at least one of the plurality of numerical controllers performs first servo control on the motor and sound data of a sound in opposite phase to a sound generated by operating a machine tool, a robot, or an industrial machine in association with each other. According to the numerical control system, since the generated sound can be canceled as feed forward in conjunction with at least one of the position information and the speed information, it is possible to obtain a high noise reduction effect with little delay.

(8) In the numerical control system according to (7) above, the storage unit stores sound data of a sound in opposite phase to the sound after canceling the sound generated by the machine tool, the robot, or the industrial machine in association with the information.

(9) In the numerical control system according to (7) or (8) above, the server stores a numerical control program that causes the motor that operates the machine tool, the robot, or the industrial machine to operate.

(10) A noise reduction method for a numerical controller (for example, a numerical controller 200 or 200A) that controls a motor (for example, a motor 261, 262, or 263) that operates a machine tool, a robot, or an industrial machine, the noise reduction method including: controlling the motor in a servo control manner based on a numerical control program; storing, in a storage unit, information including at least one of position information and speed information of the motor when first servo control of the motor is performed and sound data of a sound in opposite phase to a sound generated by operating the machine tool, the robot, or the industrial machine in association with each other; when performing second servo control on the motor operating with at least one of position information equal to the position information and speed information equal to the speed information, reading the sound data of the opposite-phase sound from the storage unit based on at least one of the position information and the speed information in at least the second servo control; and using the sound data of the opposite-phase sound read to cancel the sound generated by the machine tool, the robot, or the industrial machine. According to the noise reduction method, since the generated sound can be canceled as feed forward in conjunction with at least one of the position information and the speed information, it is possible to obtain a high noise reduction effect with little delay.

### EXPLANATION OF REFERENCE NUMERALS

100 storage device
110 noise-reduction data storage unit
120 NC program storage unit
200, 200A numerical controller
210 noise-reduction data management unit
220 NC control unit
230 noise reduction control unit
240 speaker
250 microphone
261, 262, 263 motor
300 noise-reduction data server
400 network
500 server

1. A numerical controller that controls a motor that operates a machine tool, a robot, or an industrial machine, the numerical controller comprising:
a control unit that controls the motor in a servo control manner based on a numerical control program; and
a noise-reduction data management unit that stores, in a storage unit, information including at least one of position information and speed information of the motor when the control unit performs first servo control on the motor and sound data of a sound in opposite phase to a sound generated by operating the machine tool, the robot, or the industrial machine in association with each other, wherein
when performing second servo control on the motor operating with at least one of position information equal to the position information and speed information equal to the speed information, the control unit outputs at least one of the position information and the speed information in at least the second servo control to the noise-reduction data management unit, the noise-reduction data management unit reads and outputs the sound data of the opposite-phase sound from the storage unit based on at least one of the position information and the speed information in the second servo control, and
the sound data of the opposite-phase sound output from the noise-reduction data management unit is used to cancel the sound generated by the machine tool, the robot, or the industrial machine.

2. The numerical controller according to claim 1, wherein the noise-reduction data management unit stores, in the storage unit, a program line number of the numerical control program or an internal step number loaded in units of commands by program analysis of the numerical control program.

3. The numerical controller according to claim 1, further comprising a noise reduction control unit that outputs the sound data of the opposite-phase sound output from the noise-reduction data management unit so as to cancel the sound generated by the machine tool, the robot, or the industrial machine.

4. The numerical controller according to claim 3, wherein the noise reduction control unit adjusts sound data of an opposite-phase sound output from the noise-reduction data management unit, by feedback control using sound data of a sound in opposite phase to the sound after canceling the sound generated by the machine tool, the robot, or the industrial machine.

5. The numerical controller according to claim 3, wherein when the storage unit does not store the sound data of the opposite-phase sound, the noise reduction control unit generates and outputs sound data in opposite phase to the sound generated by the machine tool, the robot, or the industrial machine.

6. The numerical controller according to claim 1, wherein, in the first servo control and the second servo control, the position information is a position command and the speed information is a speed command.

7. A numerical control system comprising:
a plurality of numerical controllers including the numerical controller according to claim 1; and
a server connected to the plurality of numerical controllers via a network, wherein
the server includes a storage unit that stores information including at least one of position information and speed information of a motor when at least one of the plurality of numerical controllers performs first servo control on the motor and sound data of a sound in opposite phase to a sound generated by operating a machine tool, a robot, or an industrial machine in association with each other.

8. The numerical control system according to claim 7, wherein the storage unit stores sound data of a sound in opposite phase to the sound after canceling the sound generated by the machine tool, the robot, or the industrial machine in association with the information.

9. The numerical control system according to claim 7, wherein the server stores a numerical control program that causes the motor that operates the machine tool, the robot, or the industrial machine to operate.

10. A noise reduction method for a numerical controller that controls a motor that operates a machine tool, a robot, or an industrial machine, the noise reduction method comprising:
controlling the motor in a servo control manner based on a numerical control program;
storing, in a storage unit, information including at least one of position information and speed information of the motor when first servo control of the motor is performed and sound data of a sound in opposite phase to a sound generated by operating the machine tool, the robot, or the industrial machine in association with each other;
when performing second servo control on the motor operating with at least one of position information equal to the position information and speed information equal to the speed information, reading the sound data of the opposite-phase sound from the storage unit based on at least one of the position information and the speed information in at least the second servo control; and
using the sound data of the opposite-phase sound read to cancel the sound generated by the machine tool, the robot, or the industrial machine.
